(19) United States
(12) Patent Application Publication
(10) Pub. No.: US 2007/0050537 A1
(43) Pub. Date: Mar. 1, 2007

(54) Flash memory device including a multi buffer program scheme

(76) Inventor: Ji-Ho Cho, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/510,762

(22) Filed: Aug. 28, 2006

(30) Foreign Application Priority Data
Aug. 29, 2005 (KR) 2005-79453

(51) Int. Cl. G06F 12/00

(52) U.S. Cl. 711/103

(57) ABSTRACT

A memory device comprises of a first buffer including programmable data. The memory device also comprises of a second buffer including real time information related to a load status of the programmable data in the first buffer. The memory device also comprises of a buffer control circuit which activates an output of the second buffer to provide the load status information in response to a control signal, while the programmable data is being loaded into the first buffer.

### BACKGROUND OF THE INVENTION

1. Field of the Invention

The present invention relates to a semiconductor memory device and, more particularly, to a flash memory device including a multi buffer program scheme.

2. Description of the Related Art

Flash memory devices are used in a variety of computing equipment such as, for example, personal computers, laptops, and mobile devices. A flash memory device has many features. One important feature is that flash memory devices are nonvolatile memory devices. That is, flash memory devices retain data even when their power supplies are interrupted. Flash memories include mask read-only memories (MROMs), programmable read-only memories (PROMs), erasable programmable read-only memories (EPROMs), and electrically erasable programmable read-only memories (EEPROMs), flash memory devices. Flash memory is mainly classified into a NAND type flash memory and a NOR type flash memory. In NOR type flash memory, a plurality of memory cells are connected to one bit line in parallel. On the other hand, in NAND type flash memory, a plurality of memory cells are connected to one bit line in series.

The NOR type flash memory has certain advantages over NAND type flash memory. For example, NOR type flash memory can operate at higher speeds than NAND type flash memory. That is, the NOR type flash memory can perform program and read operations at a higher speed than NAND type flash memory. In particular, NOR type flash memory includes a multi buffer program scheme which improves the programming speed of a NOR type flash memory device. In a multi buffer program scheme, a large amount of program data is first loaded into a multi buffer and subsequently, the large amount of program data that is loaded into the multi buffer, is programmed into a cell array.

FIG. 1 is a timing diagram illustrating a multi buffer program scheme of a conventional NOR type flash memory device. Referring to FIG. 1, when a chip enable signal nCE is activated to be at a low level, and a write enable signal nWE is toggled at the same time, a program start command CMD1 is input into the flash memory device. In general, the program start command CMD1 is inputted through addresses A0˜A1 and data D0˜D1, in synchronization with the transition of the write enable signal nWE. Thereafter, a program address PA and a program data PD are input in synchronization with the transition of the write enable signal nWE. The amount of data that may be programmed into the cell array is based on the capacity of the multi buffer. For instance, if the multi buffer has a size of 128W (here, W denotes a unit of a word) and an input/output (I/O) bit structure is ×16, the write enable signal nWE would be toggled 128 times for loading 128 words of the program data into the multi buffer. As illustrated in FIG. 1, the program address PA and the program data PD may be loaded into the multi buffer by toggling the write enable signal 128 times.

In the conventional multi buffer program scheme, as shown in FIG. 1, the data stored in the cell array may be output to an external device (not shown) during a loading period tL. That is, data may be output from the cell array at the same time when program data is being loaded into the multi buffer. Thus, as shown in FIG. 1, data may be output from the memory cell array when an output enable signal nOE transitions to low logic and when the write enable signal nWE stops toggling. At this time, a read data RD1 read out from the cell array is output to an external device. Read data RD1 may be read out in accordance with an address RA1 inputted in synchronization with the transition of the output enable signal nOE. Likewise, a read data RD2 read out from the cell array is outputted to an external device in accordance with an address RA2 when the output enable signal nOE transitions to a low level and when the write enable signal nWE stops toggling.

The type of data being read from the cell array depends on the address of the cells in the cell array. For example, if the addresses RA1 and RA2 indicate a cell array into which data that is currently being loaded into the multi buffer will be programmed, the read data RD1 and RD2 which is denoted as \textcircled{1} and \textcircled{2} in FIG. 1, respectively, is the data of cells whose data has been erased so that the cells may be reprogrammed during the loading period tL of the program data. On the other hand, if other addresses such as a bank address, a block address, etc, that do not indicate cells to be programmed are inputted into the memory device, data that is stored in these cells may be output during a read data operation of the memory device.

Once the program data is loaded into the multi buffer, a program confirm command CMD2 is input in synchronization with the transition of the write enable signal nWE. Afterwards, as illustrated in FIG. 1, if an address RA3 is input in synchronization with the transition of the output enable signal nOE, the flash memory device outputs a state data SD indicating a program busy state, which is denoted as \textcircled{3} in FIG. 1.

While the prior art memory device provides the capability to read data from a cell array while program data is being loaded into the multi buffer, the prior art memory device suffers from various shortcomings. For example, the prior art memory device does include the capability of outputting internal state information of the flash memory device to an external device in addition to the cell data, during the loading period of the program data.

The present disclosure is directed towards overcoming one or more shortcomings associated with the prior art memory device.

### SUMMARY OF THE INVENTION

One aspect of the present disclosure includes a memory device. The memory device comprises of a first buffer including programmable data. The memory device also comprises of a second buffer including real time information related to a load status of the programmable data in the first buffer. The memory device also comprises of a buffer control circuit which activates an output of the second buffer to provide the load status information in response to a control signal, while the programmable data is being loaded into the first buffer.

Another aspect of the present disclosure includes a memory device. The memory device comprises of a first buffer including programmable data. The memory device also comprises of an address input circuit which supplies an external address corresponding to the programmable data, to the first buffer. The memory device also comprises of a second buffer including information related to a load status of the programmable data in the first buffer. The memory device also comprises of a buffer control circuit which loads the programmable data into the first buffer in response to a program start command and activates an output of the second buffer to provide the load status information in response to an external control signal and the external address, while the programmable data is being loaded into the first buffer.

Yet another aspect of the present disclosure includes a memory device. The memory device comprises of a multi buffer which receives program data corresponding to a buffer address. The memory device also comprises of an address input circuit which supplies the buffer address in response to an external address, and which generates a comparison signal indicating whether or not a currently input external address is in accord with a reference address. The memory device also comprises of a status data buffer which stores load status information of the program data loaded into the multi buffer. The memory device also comprises of a buffer control circuit which controls an output buffer in response to the comparison signal to output the load status information to an external device.

Another aspect of the present disclosure includes a method for programming a memory device, the memory device including a program scheme to program data into a cell array after the program data is loaded into a multi buffer. The method comprises of stopping the programming of the data into the cell array while the data is being loaded into the multi buffer. The method also comprises of outputting a load status information that includes at least one of the program data loaded into the multi buffer and a count number of the program data.

Yet another aspect of the present disclosure includes a method for programming a memory device, the memory device including a program scheme to program data into a cell array after a plurality of program data are loaded into a multi buffer. The method comprises of inputting a program start command. The method also comprises of loading the plurality of program data and an address corresponding to each of the plurality of program data into the multi buffer, in response to the program start command. The method also comprises of inputting a program confirm command to program the plurality of program data loaded into the multi buffer into the cell array, after the loading of the plurality of program data. The method also comprises of programming the plurality of loaded program data of the multi buffer into the cell array. The method also comprises of obtaining a load status information of the multi buffer through an external control signal and an external address

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a timing diagram illustrating a conventional multi buffer program operation;

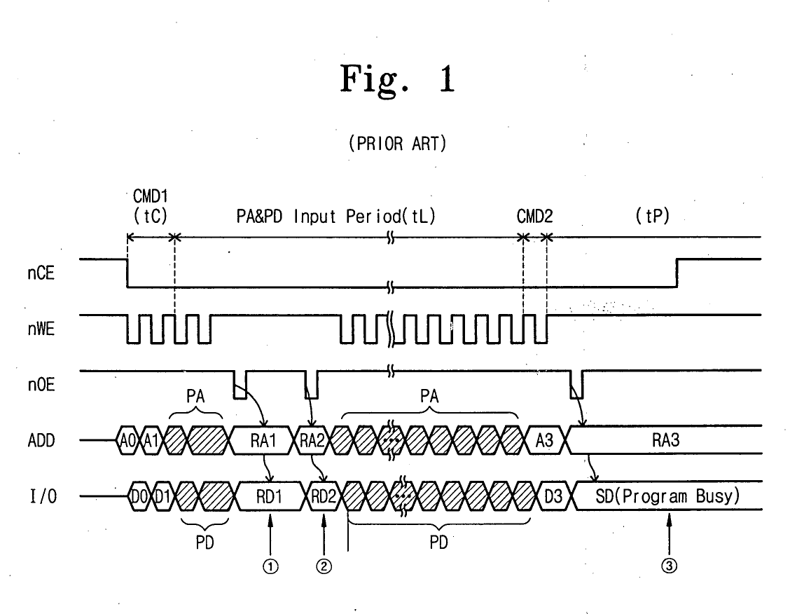

FIG. 2 is a block diagram of a flash memory device according to a first embodiment of the present invention;

FIG. 3A is a block diagram illustrating one embodiment of an address input circuit in the flash memory device according to the first embodiment of the present invention;

FIG. 3B is a block diagram illustrating another embodiment of an address input circuit in the flash memory device according to the first embodiment of the present invention;

FIG. 4 is a block diagram of a flash memory device according to a second embodiment of the present invention;

FIG. 5A is a block diagram illustrating one embodiment of an address input circuit in the flash memory device according to the second embodiment of the present invention;

FIG. 5B is a block diagram illustrating another embodiment of an address input circuit in the flash memory device according to the second embodiment of the present invention; and

FIG. 6 is a timing diagram illustrating a multi buffer loading operation of the flash memory device according an exemplary disclosed embodiment.

### DETAILED DESCRIPTION OF THE INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

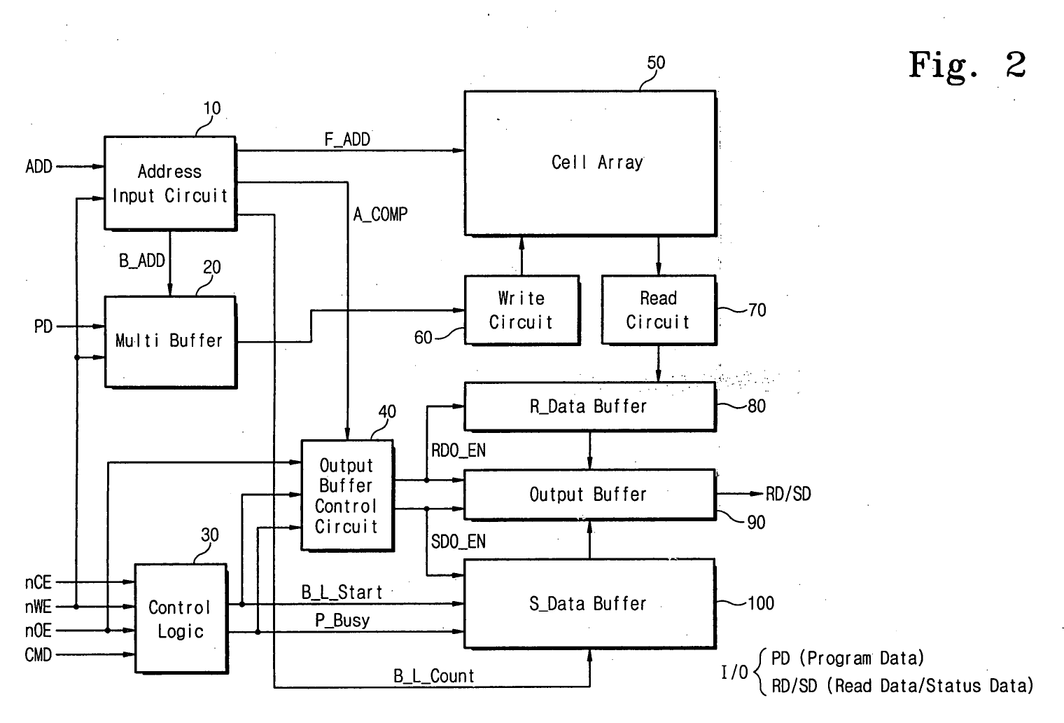

FIG. 2 is a block diagram of a flash memory device 5 according to a first embodiment of the present invention. Memory device 5 includes an address input circuit 10, a multi buffer 20, a control logic 30, an output buffer control circuit 40, a cell array 50, a write circuit 60, a read circuit 70, a R_data buffer 80, an output buffer 90, and a S_data buffer 100.

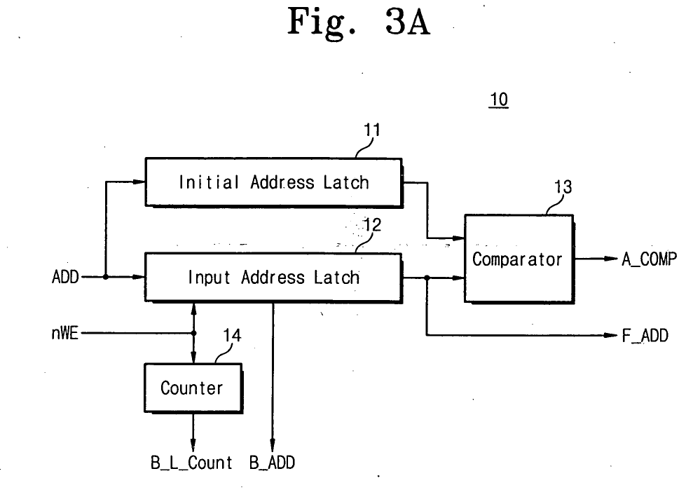

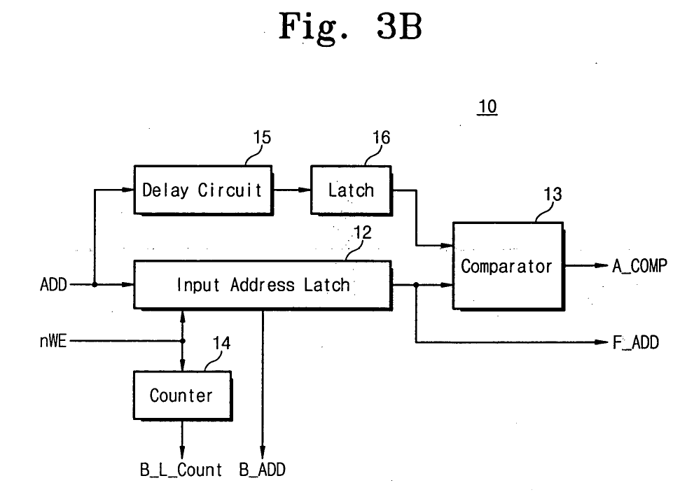

The address input circuit 10 generates three signals—a buffer address signal B_ADD, an address comparison signal A_COMP, and the load count number signal B_L_Count. Referring to FIG. 2, the address input circuit 10 receives an external address ADD from an external device (not shown). The address input circuit 10 converts the received address into the buffer address B_ADD. Buffer address B_ADD is used for loading data into the cell array 50 and the multi buffer 20. In an exemplary embodiment, the buffer address B_ADD applied to the multi buffer 20 may have a value corresponding to a lower address bit of the external address ADD. In addition, after the program start command CMD1 is inputted, the address input circuit 10 compares a currently inputted address with an address input just before the currently inputted address or some other initial address. As a result of the comparison, the address input circuit 10 outputs the address comparison signal A_COMP. Furthermore, the address input circuit 10 transmits the load count number B_L_Count to the status data buffer 100. The load count number B_L_Count is the number of data bits/bytes loaded into the multi buffer 20. A detailed operation and constitution of the address input circuit 10 will be illustrated later in FIGS. 3A and 3B.

The multi buffer 20 is a buffer memory that is used for temporarily storing data that needs to be programmed into the cell array 50. One skilled in the art will appreciate that the multi buffer 20 of the exemplary embodiment may not be just one physical buffer unit having a data capacity of I/O unit but may instead include a plurality of buffers such that the multi buffer 20 has a data capacity of a plurality of I/O units. As described above, the address of the multi buffer 20 into which a program data PD inputted from an external device is loaded, is the buffer address B_ADD that is provided from the address input circuit 10. The number of buffer addresses needed to load data into the multi buffer 20 may depend on the size of the I/O unit. For example, if the amount of data loaded into the multi buffer 20 is 128W, 128 buffer addresses B_ADD may be needed if the I/O unit is 1 word. After all the data is loaded into the multi buffer 20, the loaded data may be transmitted to a write circuit 60. Data in the write circuit 60 may be programmed into the cell array 50.

The control logic 30 generates signals indicating the status of the multi buffer 20. As shown in FIG. 2, the control logic 30 outputs a buffer load start signal B_L_Start and a program busy signal P_Busy in response to external control signals nCE, nWE, and nOE and a command CMD. In particular, the buffer load start signal B_L_Start and the program busy signal P_Busy are signals indicating that data is being loaded into the multi buffer 20. One skilled in the art will appreciate that control logic 30 may be used to generate other signals besides the B_L_Start and P_Busy signals. For example, the control logic 30 may also generate a signal indicating the completion of the process of loading data into the multi buffer 20.

The output buffer control circuit 40 operates in response to input signals, and determines whether a read data R_Data read out from the cell array 50 is output or whether a status data S_Data is output. In particular, the output buffer control circuit 40 receives the output enable signal nOE, the buffer load start signal B_L_Start, the program busy signal P_Busy, and the address comparison signal A_COMP, and generates output buffer control signals RDO_EN and SDO_EN. The output buffer control signal RDO_EN activates an output buffer 90 and a read data buffer 80 so as to output the data read from the cell array 50. The output buffer control signal SDO_EN activates the status data buffer 100 and the output buffer 90 to output the status data S_Data. Table 1 is a truth table that illustrates a control operation of the output buffer control circuit 40.

TABLE 1

| Input | | | | Output | |
|---|---|---|---|---|---|
| nOE | B_L_Start | P_Busy | A_Comp | SDO_EN | RDO_EN |
| H | X | X | X | L | L |
| L | L | X | X | L | L |
| L | H | L | H | H | L |
| L | H | L | L | L | H |
| L | H | H | X | H | L |

In Table 1, ‘H’, ‘L’, and ‘X’ denote ‘high’, ‘low’, and ‘don't care’, states respectively. Furthermore, ‘L’ and ‘H’ mean ‘logic low’ and ‘logic high’, respectively. Because the write enable signal nWE becomes ‘H’ at the point that the output enable signal nOE becomes ‘L’, a logic value for the write enable signal nWE is omitted herein.

Referring to Table 1, when the address comparison signal A_COMP is in ‘H’ and the output enable signal nOE is toggled, the output buffer control circuit 40 activates the output buffer 90 and the status data buffer 100 such that the status data is outputted. That is, when the address comparison signal A_COMP is in logic high and the output enable signal nOE is being toggled, the output buffer control circuit 40 activates the output buffer control signal SDO_EN to be logic high. However, if an inputted address is not related to the output of the status data, (e.g., when the address comparison signal is in ‘L’) and the output enable signal nOE is toggled, the output buffer control circuit 40 controls the output buffer 90 and the read data buffer 80 such that the read data is outputted. That is, when the address comparison signal is in ‘L’ and the output enable signal nOE is toggled, the output buffer control circuit 40 activates the output buffer control signal RDO_EN to be logic high. Furthermore, the output buffer control circuit 40 activates the output buffer control signal SDO_EN to be high when the program busy signal P_Busy is activated to be logic high. At this time, the data stored in the status data buffer 100, e.g., the data representing the state of the program busy signal P_Busy, is outputted to an external device through the output buffer 90.

The cell array 50 includes cells where the loaded data is programmed after the data is loaded into the multi buffer 20. In addition, the cell array 50 may also include and a decoder for decoding the address F_ADD into row and column addresses. Furthermore, the stored data of the cell array 50 corresponding to the address F_ADD may be sensed and read out by the read circuit 70.

The write circuit 60 is a circuit which sequentially programs the data loaded in the multi buffer 20 into the cell array 50. In general, in case of the NOR flash memory, the write circuit 60 receives the loaded data of the multi buffer 20 and programs it into the cell array. Because the composition and operation of the write circuit 60 is well known to those skilled in the art, further descriptions will be omitted herein.

The read circuit 70 reads out data from a cell in the cell array 50 based on the external address ADD inputted in synchronization with the activation of the output enable signal nOE. Generally, the read circuit 70 includes a sense amplifier and a buffer, and reads out the data stored in the cell by sensing the threshold voltage of the cell.

The read data buffer 80 is a buffer circuit that stores the read data outputted from the read circuit 70. The read data buffer 80 is controlled by the output buffer control circuit 40. When the read data buffer 80 receives the output buffer control signal RDO_EN from the output buffer control signal 40, the read data buffer 80 receives the read data of the read circuit 70 and stores it.

The status data buffer 100 stores status data, i.e., information related to loading of the program data PD, into the multi buffer 20 in real time. The status data includes the buffer load start signal B_L_Start. The B_L_Start signal indicates whether or not a program start command is input indicating that the program data PD is being loaded into the multi buffer 20. In addition, the status data includes the program busy signal P_Busy. The P_busy indicates that all the data is loaded into the multi buffer 20 and that the loaded data is being programmed into the cell array 50. The data stored in the status data buffer 100 is output to an external device though the output buffer 90 in accordance with the control signals provided by the output buffer control circuit 40. It is important to note that the status data disclosed herein is not restricted to information indicating that the data is loaded into the multi buffer 20. Instead, the status data includes internal status information of other memory devices.

The output buffer 90 selectively receives and outputs the data outputted from the read data buffer 80 and the status data buffer 100. The selective transfer of data in and out of the output buffer 90 is based on the signals received from the output buffer control circuit 40. In particular, the data transfer is controlled by the control signals RDO_EN and SDO_EN of the output buffer control circuit 40. For example, when the output buffer control signal RDO_EN is activated, the read data buffer 80 receives the cell data and stores it. Thereafter, the data stored in the read data buffer 80 is outputted to an external device through the output buffer 90. On the other hand, when the output buffer control signal SDO_EN is activated, the status data S_Data latched at the status data buffer 100 in real time is output to an external device through the output buffer 90.

FIG. 3A is a block diagram illustrating an exemplary embodiment of the address input circuit 10 of FIG. 2. The address input circuit 10 compares the initial address and the currently inputted address with each other to generate the address comparison signal A_Comp. The comparison signal A_Comp is used for determining whether the output buffer control circuit 40 outputs the status data S_Data or the read data R_Data. In addition, the address input circuit 10 supplies the load count number B_L_Count, that indicates the number of data currently loaded into the multi buffer 20, to the status data buffer 100.

Referring to FIG. 3A, the address input circuit 10 includes an initial address latch 11, an input address latch 12, a comparator 13, and a counter 14. The initial address latch 11 stores the external address ADD, i.e., the first address input (hereinafter, referred to as initial address) after the program start command is provided. The input address latch 12 sequentially latches the inputted external address ADD in real time. The comparator 13 compares a currently inputted real-time address with the initial address so as to output the comparison result. The counter 14 counts the amount of data loaded into the buffer to provide the load count number B_L_Count. This load count number is known as the status data. In an exemplary embodiment, the load count number may indicate the amount of data loaded in terms of bytes. As shown in FIG. 3A, the address input circuit 10 may receive the external address ADD in synchronization with the write enable signal. Furthermore, the address input circuit 10 may output the load count number B_L_Count, the addresses B_ADD and F_ADD, and the address comparison signal A_Comp.

The initial address latch 11 is a latch circuit for storing the address inputted first after the input of the program start command. The initial address is an address corresponding to the data which is first loaded into the multi buffer 20. The loaded data may be part of a number of words of program data. The number of words of program data being loaded into the multi buffer 20 depends on the buffer size, e.g., 128-words program data. The initial address is latched at the initial address latch 11 whenever the program start command is inputted, and is maintained till the data loaded into the multi buffer 20 is programmed into the cell array 50. One skilled in the art will appreciate that the control signals may be used to contol the operation of the initial address latch 11.

The input address latch 12 is a latch circuit for temporarily storing the currently inputted address. The currently inputted address includes the external address ADD inputted in real time whenever the write enable signal nWE is toggled.

The comparator 13 compares the input addresses to generate the address comparison signal A_Comp. The address comparison signal A_Comp is transferred to the output buffer control circuit 40. The output buffer control circuit 40 uses the comparison signal A_Comp to determine whether to output the status data S_Data or the read data R_Data. The comparator 13 makes this determination by comparing the currently inputted real-time address with the initial address, and detecting whether the currently inputted address is identical in buffering size to the initial address or an address of a memory bank or a sector which is different from the initial address. If the initial address stored in the initial address latch 11 and the currently inputted real-time address temporarily stored in the input address latch 12 have the same buffering size, the address comparison signal A_Comp becomes logic high. On the other hand, if the buffering sizes are not the same, the address comparison signal A_Comp is becomes logic low.

The operation of the comparator 13 can be based on setting the number of bits that may be used for comparison between the initial address and the currently inputted address. For example, if the buffering size of the multi buffer 20 is 128 words, it is possible to detect whether or not the buffering size of the currently input address is identical to that of the currently input address by comparing only an upper address of a bank, a sector, and a block. Thus, the lower 7 bits corresponding to the buffer address B_ADD among the total address bits are excluded. In the following table 2, an address structure of a NOR flash memory is described in brief for illustrating an exemplary embodiment of the present invention.

TABLE 2

| Upper Address | | | | | | | Lower Address | | | | | | |
|---|---|---|---|---|---|---|---|---|---|---|---|---|---|
| A23 | A22 | A21 | . . . | A9 | A8 | A7 | A6 | A5 | A4 | A3 | A2 | A1 | A0 |

Referring to table 2, the upper address includes bits indicating the addresses of the bank, the block, and the sector of the cell array 50. The lower address includes the bits below the upper address bits. Furthermore, the lower address may be used as the buffer address B_ADD loaded into the multi buffer 20, in case that the inventive multi buffer 20 has a size of 128 words. Each buffer in the multi buffer 20 may be assigned a 7-bit address. In an exemplary embodiment, the comparator 13 receives the upper addresses from the initial address latch 11 and the input address latch 12 and compares them with each other. If the upper addresses have different bits from each other, the address comparison signal A_Comp is output as logic low. On the other hand, if the upper addresses have the same bits, the address comparison signal A_Comp is output as logic high. While the above described method may be used to determine if the currently input address has the same buffer size as that of a previously input address, one skilled in the art will appreciate that other methods may also be used to compare the buffer sizes of the two addresses.

The counter 14 counts the number of input data that is loaded into the multi buffer 20 and provides the counting result as status information. In an exemplary embodiment, the counter 14 counts the number of data input in synchronization with the write enable signal nWE and transmits the number of such data in the form of a signal, i.e., the load count number signal, B_L_Count, to the status data buffer 100.

FIG. 3B is a block diagram illustrating an alternative exemplary embodiment of the address input circuit 10. Herein, like reference numerals in FIG. 3B denote like elements of FIG. 3A. The address input circuit 10 of FIG. 3B is substantially identical to that of FIG. 3A except that the initial address latch 11 is replaced by a delay circuit 15 and a latch 16.

The delay circuit 15 is a circuit which delays the input address by one clock. The input address may be delayed in various ways. For example, the input address may be delayed by an external clock that is operating in a synchronous mode. On the other hand, the input address may be delayed in synchronization with a toggling of the write enable signal nWE that is in an asynchronous mode. Assuming that a loading unit of the data that is loaded into the multi buffer 20 is a word unit, the delay circuit 15 may be set such that an address input before the currently inputted address is stored in the latch 16. The latch 16 is a latch circuit in which the address delayed by the delay circuit 15 is temporarily stored.

Similar to address input circuit 10 of FIG. 3A, the address input circuit 10 of FIG. 3B compares the currently input address and the address input just before the currently input address with each other to generate the address comparison signal A_Comp. The address comparison signal A_Comp is used for determining whether the output buffer control circuit 40 outputs the status data S_Data or the read data R_Data. In addition, the address input circuit 10 may provide the buffer address B_ADD for loading the program data into the multi buffer 20. Furthermore, the address input circuit 10 may also provide the load count number B_L_Count, which indicates the number of the data that is currently loaded into the multi buffer 20, as the status information.

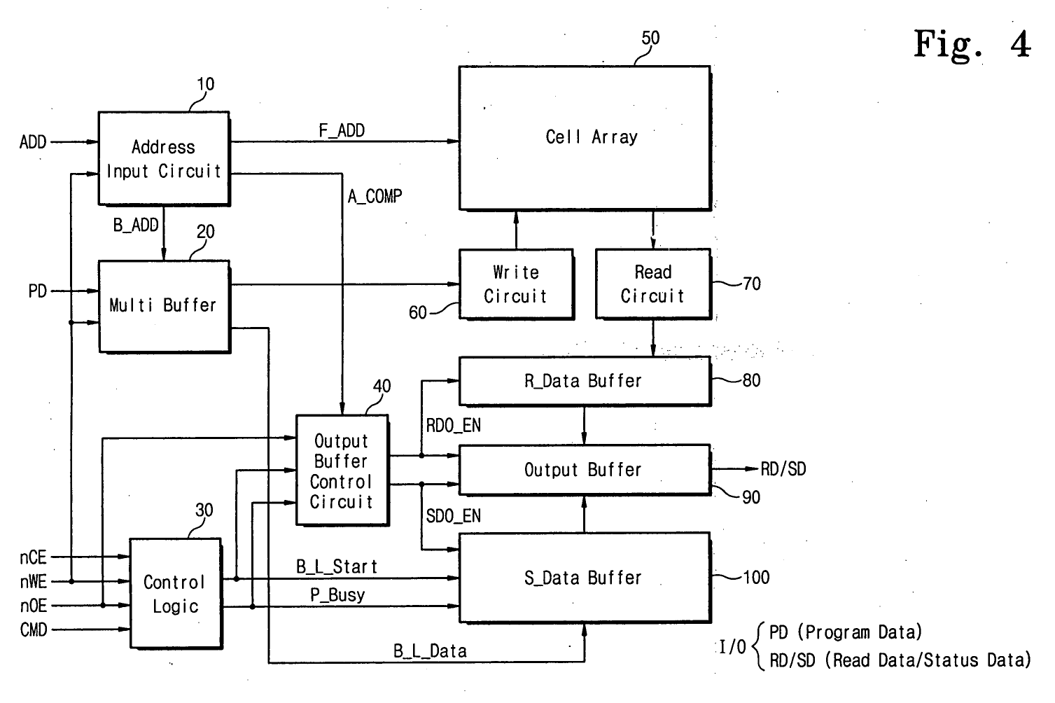

FIG. 4 is a block diagram of a flash memory device 7 according to a second embodiment of the present invention. Herein, like reference numerals in FIG. 4 denote like elements of FIG. 2. The flash memory device of the second embodiment is substantially identical to that of the first embodiment, except that the address input circuit 10 does not generate the load count number B_L_Count as the status information. Instead, the load data B_L_Data of the multi buffer 20 is output as the status information.

The flash memory device 7 is capable of outputting the data loaded from the memory cell array 50 into the multi buffer 20, to an external device, while the program data is being loaded into the multi buffer 20, after the input of the program start command. Furthermore, the data may be output if the write enable signal nWE stops being toggled but the output enable signal nOE is activated to be logic low.

The address input circuit 10 supplies the address comparison signal A_Comp and the addresses F_ADD and the B_ADD to the corresponding elements of the flash memory device 7. However, unlike the address input circuit 10 of FIG. 3A and FIG. 3B, the address input circuit 10 does not include a counter for counting the number of the data loaded into the buffer. In an alternative embodiment, it is possible to set the address input circuit 10 such that it includes the counter but does not provide the output of the counter as the status data.

In the multi buffer 20 of the flash memory device 7, the program data PD is loaded into each buffer assigned by the buffer address B_ADD when the write enable signal is being toggled. However, the load data that is loaded to a corresponding address is output to the status data buffer 100 when the buffer address B_ADD is input after the write enable signal nWE is activated to the logic high state.

The flash memory device 7 can output the data loaded into the multi buffer 20 from the cell array 50, to an external device, while the program data is being loaded into the multi buffer 20 after the input of the program start command. This output of data to the external device may occur if the output enable signal nOE is being toggled and the write enable signal nWE is maintained to be logic high.

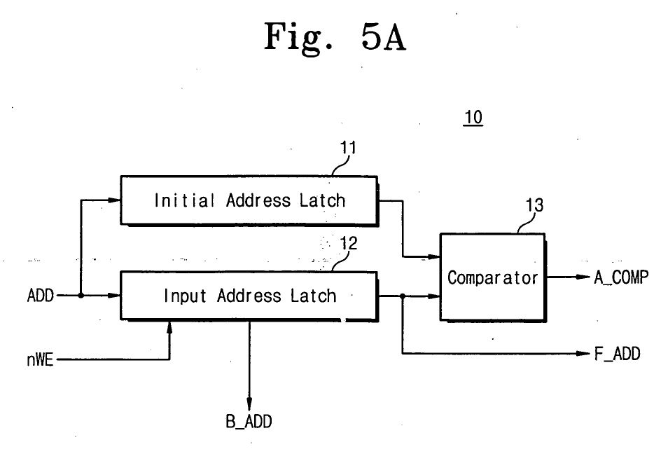

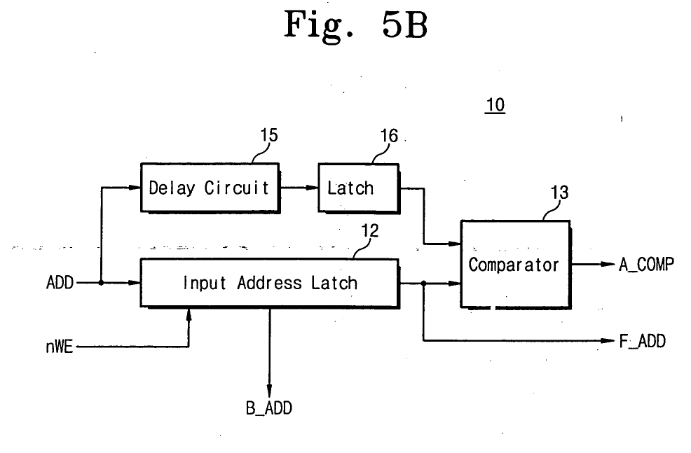

FIG. 5A is a block diagram illustrating one embodiment of the address input circuit 10 of FIG. 4. Herein, like reference numerals in FIG. 5A denote like elements of FIG. 3A, and thus their descriptions will be omitted. The address input circuit 10 of FIG. 5A is substantially similar to that of FIG. 3A, except that the address input circuit 10 of FIG. 5A does not include the counter 14 to output the load count number B_L_Count of the multi buffer 20 to the status data buffer 100.

FIG. 5B is a block diagram illustrating another embodiment of the address input circuit 10 of FIG. 4. The address input circuit 10 of FIG. 5B is substantially similar to that of FIG. 3B, except that the address input circuit 10 of FIG. 5B does not include the counter 14 to output the load count number B_L_Count of the multi buffer 20 to the status data buffer 100.

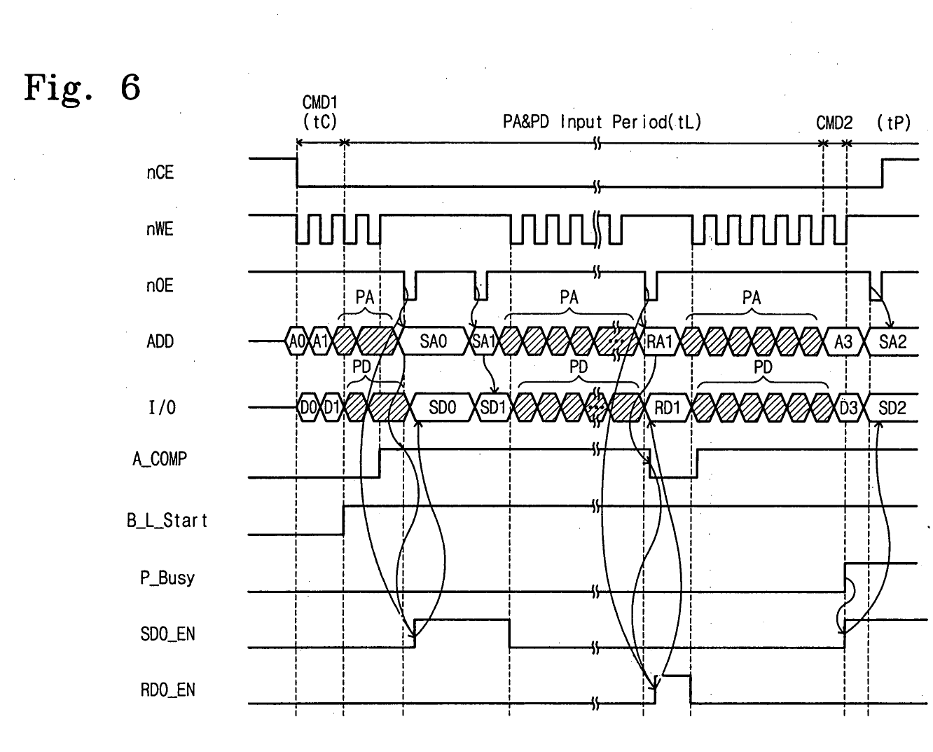

FIG. 6 is a timing diagram illustrating an operation of the flash memory device according to an exemplary disclosed embodiment. The operation of the flash memory according to an exemplary disclosed embodiment will now be set forth in detail with reference to FIGS. 2 to 5 as well as FIG. 6.

To begin with, the program start command or the buffer load start command is input in synchronization with the toggling of the write enable signal nWE during a period tC when the chip enable signal nCE is activated to be logic low. The program start command CMD1, which is denoted as D0˜D1 in FIG. 6, may be inputted through each address A0˜A1 and a data I/O pin during 2-cycles of the write enable signal nWE. Although the program start command CMD1 is input for two clocks in FIG. 6, it is obvious to those skilled in the art that the program start command CMD1 may also be input for three clocks or more.

After the program start command CMD1 is input, the buffer load start signal B_L_Start, which indicates whether the load command is input into the multi buffer 20, transitions to logic high. The transitioning of the B_L_Start signal to a logic high state indicates the beginning of the loading of data into the multi buffer 20. Furthermore, the program address PA and the corresponding program data PD maybe input in sequence when the B_L_Start transitions to a logic high state. The number of times the write enable signal nWE has to be toggled to load the multi buffer 20 depends on the number of words that may be input within each cycle of the write enable signal nWE. For example, if one word is input when the write enable signal nWE is toggled one time and if 128 words have to be loaded into the multi buffer 20, the program data PD and the program address PA may be input by toggling the write enable signal nWE 128 times. After the loading of the data into the multi buffer 20 is completed and the program confirm command CMD2 is input, the data loaded into the multi buffer 20 is programmed into the memory cell corresponding to the inputted address. The aforementioned illustration assumes that the flash memory device operates normally and that the write enable signal nWE is not toggled in the middle of loading the data into the multi buffer 20.

The operation for checking the loading state, i.e., the status of data loaded into the multi buffer 20 will now be described. In order to check the status data S_Data while the data is being loaded into the multi buffer 20, the input of the data is stopped by simultaneously transiting the write enable signal nWE to logic high and the output enable signal nOE to logic low. The address SA0 inputted at this time enables one of the program addresses PA be inputted, wherein the program addresses are inputted for loading the program data into the multi buffer 20. In FIG. 6, the address SA0 corresponds to the last address input among the program addresses PA inputted previously. In this case, based on the states described in table 1, the output of the output buffer control circuit 40, i.e., the output buffer control signal SDO_EN is transited to be logic high. This is because the address comparison signal A_Comp is in logic high and the loading of the data is not completed. As the output buffer control signal SDO_EN is activated to be logic high, the status data stored in real time in the status data buffer 100 is output to an external device through the output buffer 90. The status data SD0, may vary depending on the embodiment of the present invention. For example, in the flash memory device 5, the status data SD0 may include the buffer load start signal which indicates whether the program start command CMD1 is input or not and the load count number B_L_Count indicating the number of the data loaded into the multi buffer 20. Alternatively, in the flash memory device 7, the status data SD0 may include the buffer load data B_L_Data loaded into the multi buffer 20 corresponding to the address SA0, instead of the load count number B_L_Count.

FIG. 6 also includes the timing diagram associated with checking data stored in memory banks or sectors that are unrelated to the currently input address of the buffering size while the data is loaded into the multi buffer 20. In FIG. 6, this corresponds to a third toggling of the output enable signal nOE. In this case, though the procedure and method for checking the status data are similar to that described above, the input address is different. That is, to this end, the input address RA1 includes upper bits that indicate another bank or sector. Furthemore, the output enable signal nOE is toggled while maintaining the write enable signal to be in logic high. At this time, the address comparison signal A_Comp is transited to be logic low and the output buffer control circuit 40 activates the output buffer control signal RDO_EN to be logic high. Under this condition, the output buffer 80 outputs the read data RD1 of the read data buffer 80 in response to the activated output buffer control signal RDO_EN. The read data RD1 is a data read out from the cell array which indicates the address RA1.

After the multi buffer 20 is fully loaded, the flash memory devices 5 and 7 may also provide a signal indicating that the data loaded into the multi buffer 20 is being programmed into the cell array 50. In particular, after the loading of the data into the multi buffer 20 is complete and the program confirm command CMD2 (for example, denoted as A3 and D3 in FIG. 6) is input, the program busy signal P_Busy, i.e., one of the status data, may be output. The program busy signal P_Busy indicates that the loaded data into the multi buffer 20 is being programmed into the cell array. Herein, the period after the loading of the data is denoted as tP in FIG. 6. Furthermore, the output enable signal will toggle again at this time. For example, as shown in FIG. 6, the output enable signal nOE toggles for a fourth time at this state.

As illustrated in FIG. 6, when the program busy signal P_Busy becomes logic high, the output buffer control circuit 40 activates the output buffer control signal SDO_EN to be logic high in response to the program busy signal P_Busy. This enables the data stored in the status data buffer 100, i.e., the data indicating the program busy state, to be output through the output buffer 90. Although the illustrated embodiments indicate that the program confirm command CMD2 is input from an external device, the program confirm command CMD2 may also be generated internally. For example, the program confirm command may be generated by the count number of the program data. Accordingly, it is possible to configure the disclosed flash memory devices such that when the loading of data into the multi buffer 20 is complete, the loaded data is automatically programmed into the cell array without the inputting of an external command.

The disclosed memory devices may be used in any apparatus that includes flash memory. The disclosed memory devices include the capability of outputting overall status data while the data is being loaded into the multi buffer. The status data outputted from the disclosed memory devices may be used to ensure the reliable loading of data into the multi buffer.

It will be apparent to those skilled in the art that various modifications and variations can be made to the disclosed memory devices without departing from the scope of the disclosure. Additionally, other embodiments of the disclosed devices will be apparent to those skilled in the art from consideration of the specification. It is intended that the specification and the example be considered exemplary only, with a true scope of the disclosure being indicated by the following claims and their equivalents.

What is claimed is:

1. A memory device comprising:
a first buffer including programmable data;
a second buffer including real time information related to a load status of the programmable data in the first buffer; and
a buffer control circuit which activates an output of the second buffer to provide the load status information in response to a control signal, while the programmable data is being loaded into the first buffer.

2. The memory device of claim 1, wherein the first buffer includes at least one address corresponding to the programmable data.

3. The memory device of claim 2, wherein the load status information includes at least one of a data loaded into the first buffer, a count value of the data, information as to whether a program start command is input or not, and information as to whether the loading of the data is complete or not.

4. The memory device of claim 1, wherein the memory device is a NOR flash memory.

5. A memory device comprising:
a first buffer including programmable data;
an address input circuit which supplies an external address corresponding to the programmable data, to the first buffer;
a second buffer including information related to a load status of the programmable data in the first buffer;
a buffer control circuit which loads the programmable data into the first buffer in response to a program start command and activates an output of the second buffer to provide the load status information in response to an external control signal and the external address, while the programmable data is being loaded into the first buffer.

6. The memory device of claim 5, wherein the programmable data has a size equal to a plurality of times of a data input/output (I/O) unit.

7. The memory device of claim 5, wherein the address input circuit comprises:
an address generator which generates an address of the first buffer from the inputted external address; and
a comparator which compares an external address input in real time and an external address input before the external address input in real time with each other to output a comparison signal.

8. The memory device of claim 7, wherein the address input circuit further comprises a counter which counts the number of the programmable data loaded into the first buffer.

9. The memory device of claim 7, wherein the comparator comprises:
a first latch which latches the external address input in real time;
a second latch which latches the external address input before the external address input in real time; and
a comparison circuit which compares the latched addresses of the first and second latches with each other to output the comparison signal.

10. The memory device of claim 9, wherein the comparison circuit compares at least one bit of the external address input in real time with at least one bit of the external address input before the external address input in real time, and detects whether the compared addresses are identical in buffer size to each other or whether the external address input in real time is unrelated to an address being buffered.

11. The memory device of claim 8, wherein the load status information includes at least one of a count value output from the counter, information as to whether the program start command is input or not, and a program busy signal which indicates that the loading of the data into the buffer is complete and that the loaded data is being programmed into a cell array.

12. The memory device of claim 5, wherein the load status information includes at least one of a data corresponding to the external address loaded into the first buffer, information as to whether the program start command is input or not, and a program busy signal which indicates that the loading of the data into the buffer is complete and that the loaded data is being programmed into a cell array.

13. The memory device of claim 5, wherein the memory device is a NOR flash memory.

14. The memory device of claim 13, wherein the external control signal includes at least one of a write enable signal and an output enable signal.

15. The memory device of claim 14, wherein the write enable signal is maintained at logic high and the output enable signal is transited to logic low, for outputting the load status information.

16. The memory device of claim 15, wherein the memory device outputs the load status information if an inputted external address corresponds to the programmable data loaded into the first buffer, but if not, the memory device outputs a data of a cell array corresponding to the inputted external address.

17. A memory device comprising:
a multi buffer which receives program data corresponding to a buffer address;
an address input circuit which supplies the buffer address in response to an external address, and which generates a comparison signal indicating whether or not a currently input external address is in accord with a reference address;
a status data buffer which stores load status information of the program data loaded into the multi buffer; and
a buffer control circuit which controls an output buffer in response to the comparison signal to output the load status information to an external device.

18. The memory device of claim 17, wherein the reference address is an external address of data which is first loaded into the multi buffer.

19. The memory device of claim 17, wherein the reference address is an external address input immediately before the currently input external address.

20. The memory device of claim 17, wherein the load status information includes a program busy status data indicating whether an operation for programming the loaded program data of the multi buffer into a cell array is being performed or not.

21. The memory device of claim 17, wherein the load status information includes a count number of the program data loaded into the multi buffer.

22. The memory device of claim 17, wherein the buffer control circuit controls a read circuit of the memory device in response to the comparison signal to output data from a cell array to an external device.

23. A method for programming a memory device, the memory device including a program scheme to program data into a cell array after the program data is loaded into a multi buffer, the method comprising:
stopping the programming of the data into the cell array while the data is being loaded into the multi buffer; and
outputting a load status information that includes at least one of the program data loaded into the multi buffer and a count number of the program data.

24. The method of claim 23, wherein the load status information further includes information related to at least one input command provided to the memory device.

25. The method of claim 23, wherein the load status information further includes information related to a program busy signal indicating whether an operation for programming the loaded program data of the multi buffer into a cell array is performed or not.

26. A method for programming a memory device, the memory device including a program scheme to program data into a cell array after a plurality of program data are loaded into a multi buffer, the method comprising:
inputting a program start command;
loading the plurality of program data and an address corresponding to each of the plurality of program data into the multi buffer, in response to the program start command;
inputting a program confirm command to program the plurality of program data loaded into the multi buffer into the cell array, after the loading of the plurality of program data;
programming the plurality of loaded program data of the multi buffer into the cell array; and
obtaining a load status information of the multi buffer through an external control signal and an external address.

27. The method of claim 26, wherein the load status information includes at least one of a count number of the loaded data among the plurality of program data, and information with respect to the inputted command.

28. The method of claim 26, wherein the load status information includes at least one of a data loaded into the multi buffer among the plurality of program data, and information with respect to the inputted command.

29. The method of claim 26, wherein the memory device outputs the load status information if an inputted external address is an address corresponding to the program data loaded into the multi buffer, but if not, the memory device outputs a data of a cell array corresponding to the inputted external address.

30. The method of claim 26, wherein the load status information includes information indicating a program busy signal after completing the loading of the program data.

31. The method of claim 26, wherein the program confirm command is internally generated in synchronization when the loading of the program data is complete.

32. The method of claim 26, wherein the memory device is a NOR flash memory.
